(19) United States
(12) Patent Application Publication
(10) Pub. No.: US 2019/0077657 A1
(43) Pub. Date: Mar. 14, 2019

(54) Gas-Loading and Packaging Method and Apparatus

(71) Applicant: IH IP Holdings Limited, St. Helier (GB)

(72) Inventors: Darren R. Burgess, Charlotte, NC (US); Michael Raymond Greenwald, Indian Trail, NC (US); Brent W. Barbee, Stanfield, NC (US)

(21) Appl. No.: 16/178,649

(22) Filed: Nov. 2, 2018

Related U.S. Application Data
(63) Continuation-in-part of application No. 15/891,416, filed on Feb. 8, 2018.
Application No. 15/891,416 is a division of application No. 15/615,137, filed on Jun. 6, 2017, now Pat. No. 10,053,362.
(60) Provisional application No. 62/346,238, filed on Jun. 6, 2016.

(51) Int. Cl. C01B 3/08; H01M 8/04119; H01M 8/0612; H01M 8/04089; C01B 3/10; H01M 8/04082

(52) U.S. Cl. CPC C01B 3/08; H01M 8/04119; H01M 8/0643; H01M 8/04216; Y02E 60/362; C01B 3/10; H01M 8/04089

(57) ABSTRACT

A gas-loading and packaging system is provided for loading a material used in a hydrogen fuel cell with gas and packaging the material in a sealed container. The gas may comprise a hydrogen gas or other gas. The material may, for example, comprise zeolite. The material is loaded with gas by exposing the material to the gas under high pressure and a cryogenic temperature of about 93 Kelvin or lower. When the material is exposed to gas under pressure and at cryogenic temperature, the gas absorbs into or adsorbs onto the material. The mass of the material is continuously monitored and used to determine when the material is loaded with the desired amount of gas. After the material is loaded with gas, high pressure and cryogenic temperature is maintained while the material is packaged and sealed in a cryogenically cooled container.

### CROSS-REFERENCE TO RELATED APPLICATION

This application is a continuation in part (CIP) application of U.S. Utility patent application Ser. No. 15/891,416, titled “Gas-Loading and Packaging Method and Apparatus,” filed on Feb. 8, 2018, which is a divisional application of U.S. Utility patent application Ser. No. 15/615,137, titled “Gas-Loading and Packaging Method and Apparatus,” filed on Jun. 6, 2017, which claims the benefit of priority of U.S. Provisional Patent Application No. 62/346,238, titled “Gas-Loading and Packaging Method and Apparatus” filed on Jun. 6, 2016 which are incorporated herein in its entirety by this reference.

### TECHNICAL FIELD

The present disclosure relates generally to alternative energy technologies and, more particularly, to methods and apparatus for gas-loading and packaging solid materials for use in hydrogen fuel cells and low-energy nuclear reactions (LENRs).

### BACKGROUND

The loading of hydrogen (or its isotopes) into a solid material is an important technology for hydrogen fuel cells and low energy nuclear reactors. A hydrogen loading ratio in palladium above 0.8 is widely believed to be a necessary condition to produce a LENR. High loading of hydrogen into a fuel cell compatible material increases the life of the fuel cell. The loading of methane into metal-organic frameworks is an important, emerging technology to increase the storage capacity of this fuel source. In each of these scenarios, the loading process must be controllable, quantifiable and sustainable to be repeatable and production-worthy.

Several techniques are known for measuring the amount of hydrogen that is loaded into a solid material. The amount of hydrogen loaded into a solid material can be quantified by measuring an increase in a sample's mass or a decrease in pressure of a fixed quantity of gas in the presence of the material.

Measuring the pressure decrease in a fixed quantity of gas suffers from one major source of error. The gas may adsorb on all surfaces present in addition to the material of interest. Also, the existing technologies do not allow for the hydrogen load to be sustained after quantification. For high purity, homogeneous materials this does not necessarily present a problem because sample of the same material may be used in other processes. In the case of multi-component materials such as layered thin films, nano-particles, or temperature sensitive alloys, sample-to-sample variability can be considerable creating a need to characterize materials for fuel cell or LENR use.

### SUMMARY

This summary is provided to introduce in simplified form concepts that are further described in the following detailed descriptions. This summary is not intended to identify key features or essential features of the claimed subject matter, nor is it to be construed as limiting the scope of the claimed subject matter.

The present disclosure describes a gas-loading and packaging apparatus. The apparatus includes a process chamber configured to receive a material to be loaded with hydrogen gas, the process chamber cooled to a cryogenic temperature of about 93 Kelvin or lower; a scale disposed inside the process chamber for measuring a mass of the material while the material is loaded with the hydrogen gas; a packaging chamber connected by a first passageway to the process chamber and configured to receive the material from the process chamber through the first passageway, the packaging chamber cooled to a cryogenic temperature of about 93 Kelvin or lower; a gas supply system including a gas source for supplying hydrogen gas under pressure to the process chamber and the packaging chamber, the gas supply system configured to in a loading mode, supply hydrogen gas to the process chamber to increase the process chamber pressure to a first pressure level sufficient to effect the loading of material with hydrogen gas while the material is disposed within the process chamber; and in a first transfer mode, supply hydrogen gas to the packaging chamber to increase the packaging chamber pressure to a second pressure level lower than the first pressure level to enable transfer of the material from the process chamber to the packaging chamber.

According to one or more embodiments, the apparatus further comprises a loading chamber connected by a second passageway to the process chamber and configured to receive the material prior to it being placed into the process chamber, the loading chamber cooled to a cryogenic temperature of about 93 Kelvin or lower; and a vacuum pump for evacuating the loading chamber prior to transfer of the material to the process chamber.

According to one or more embodiments, the gas supply system is further configured to, in a second transfer mode during which the material is transferred via the second passageway from the loading chamber to the process chamber, increase the pressure level in the process chamber sufficient to prevent the flow of contaminants from the loading chamber into the process chamber.

According to one or more embodiments, the apparatus further comprises a cryocooler configured to cool one or more of: the loading chamber, the process chamber, and the packaging chamber to a cryogenic temperature of about 93 Kelvin or lower.

According to one or more embodiments, the apparatus further comprise a cryogenically cooled container placed in the packaging chamber, wherein the cryogenically cooled container maintains its contents at a temperature of about 93 Kelvin or lower.

According to one or more embodiments, the apparatus further comprise a sealing mechanism for sealing the first passageway after the material is received within a cryogenically cooled container placed in the packaging chamber.

According to one or more embodiments, the sealing mechanism includes a thermal seal and a vapor seal.

According to one or more embodiments, the gas supply system is further configured to, in the second transfer mode, increase the process chamber pressure to at least about 10 Torr above the loading chamber pressure.

According to one or more embodiments, the gas supply system is further configured to, in the second transfer mode, increase the process chamber pressure to the range of about 10 Torr to about 50 Torr above the loading chamber pressure.

According to one or more embodiments, the apparatus further comprise a first linear transfer apparatus disposed in the loading chamber for transferring the material from the process chamber to outside of the gas-loading and packaging apparatus.

According to one or more embodiments, the apparatus further comprises a second linear transfer apparatus disposed in the process chamber for transferring the cryogenically cooled container from the process chamber.

According to one or more embodiments, the apparatus further comprises a process control circuit configured to: receive mass measurements from the scale in the process chambers obtained while the material is being loaded with hydrogen gas; calculate a change of mass of the material based on the measurements; and determine when the material is loaded with a predetermined amount of hydrogen gas based on the change in mass of the material.

According to one or more embodiments, to determine when the material is loaded with the predetermined amount of hydrogen gas, the process control circuit is further configured to compare the change of mass of the material to a threshold.

According to one or more embodiments, to determine when the material is loaded with the predetermined amount of hydrogen gas, the process control circuit is further configured to calculate the amount of hydrogen loaded onto the material based on the mass change.

According to one or more embodiments, the second pressure level is sufficiently below the process chamber pressure to prevent the flow of contaminants from the packaging chamber into the process chamber while the material is being transferred into the packaging chamber.

According to one or more embodiments, the second pressure level comprises a pressure level at least 10 Torr below the loading chamber pressure.

According to one or more embodiments, the apparatus further comprises automated packaging equipment in the packaging chamber for packaging the material within a cryogenically cooled container placed inside the packaging chamber.

Disclosed herein is a gas-loading and packaging apparatus comprising a process chamber configured to receive a liquid material to be loaded with hydrogen gas; a scale disposed inside the process chamber for measuring a mass of the liquid material while the liquid material is loaded with the hydrogen gas; a packaging chamber connected by a first passageway to the process chamber and configured to receive the liquid material from the process chamber through the first passageway; a gas supply system including a gas source for supplying hydrogen gas under pressure to the process chamber and the packaging chamber, the gas supply system configured to in a loading mode, supply hydrogen gas to the process chamber to increase the process chamber pressure to a first pressure level sufficient to effect the loading of liquid material with hydrogen gas while the liquid material is disposed within the process chamber; and in a first transfer mode, supply hydrogen gas to the packaging chamber to increase the packaging chamber pressure to a second pressure level lower than the first pressure level to enable transfer of the liquid material from the process chamber to the packaging chamber.

According to one or more embodiments, the apparatus further comprises a loading chamber connected by a second passageway to the process chamber and configured to receive the liquid material prior to it being placed into the process chamber; and a vacuum pump for evacuating the loading chamber prior to transfer of the liquid material to the process chamber.

According to one or more embodiments, the gas supply system is further configured to, in a second transfer mode during which the liquid material is transferred via the second passageway from the loading chamber to the process chamber, increase the pressure level in the process chamber sufficient to prevent the flow of contaminants from the loading chamber into the process chamber.

### BRIEF DESCRIPTION OF THE DRAWINGS

FIG. 1 is a schematic diagram illustrating a system for gas-loading and packaging a solid material.

FIGS. 2A-2C illustrate an intake process during which the sample loading chamber of the gas-loading and packaging system is evacuated and then pressurized.

FIGS. 2D and 2E illustrate a first transfer process during which the solid material is transferred from the sample loading chamber to a process chamber of the gas-loading and packaging system.

FIG. 2F illustrates a gas-loading process during which the solid material is loaded with hydrogen gas in the process chamber.

FIGS. 2G and 2H illustrate a second transfer process during which the solid material is transferred from the process chamber to a packaging chamber gas-loading and packaging system.

FIGS. 2I and 2J illustrate the packaging process during which the solid material is packaged into a sealed container.

FIG. 3 illustrates an exemplary controller for controlling the gas loading and packaging system

FIGS. 4A and 4B illustrate an exemplary method for gas-loading and packaging a solid material.

FIGS. 5A and 5B illustrate an exemplary method for gas-loading and packaging a material within a cryogenically cooled container in a cryogenically cooled environment.

### DETAILED DESCRIPTION

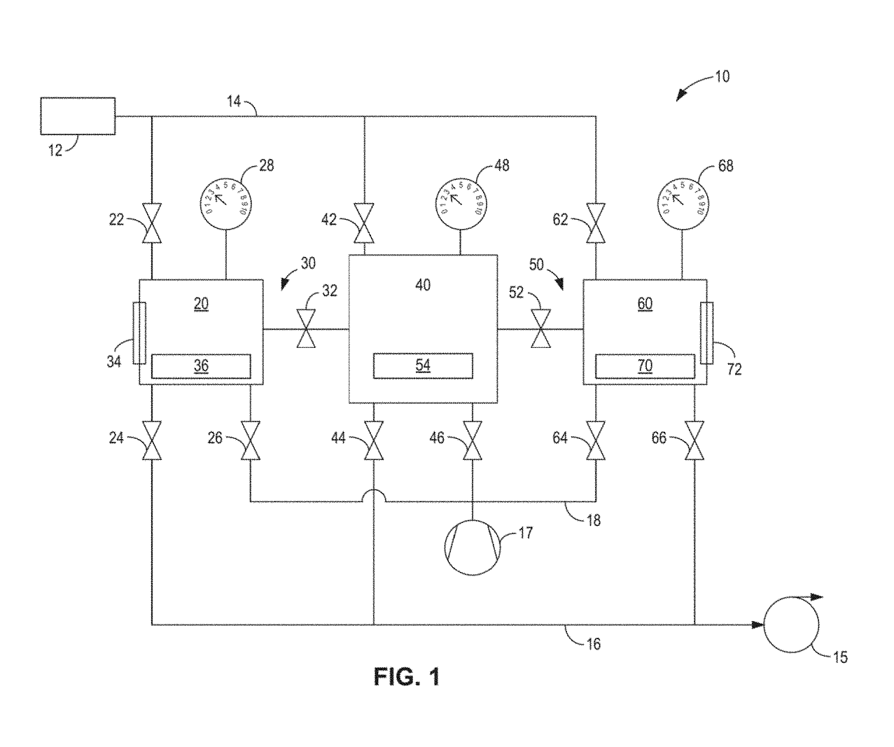

Referring now to the drawings, FIG. 1 illustrates an exemplary gas-loading and packaging system 10 according to one exemplary embodiment. The main function of the gas-loading and packaging system 10 is to load a material (solid or liquid) used in a hydrogen fuel cell or LENR with gas and package the solid material. The gas may comprise a hydrogen gas or other gas. As used herein, the term hydrogen gas includes all gaseous isotopes of hydrogen including deuterium and tritium. The solid material may, for example, comprise palladium, a nickel alloy, platinum, or other metal. The liquid material may, for example, comprise an alcohol in one embodiment; in another embodiment, the liquid material may represent any liquid capable of absorbing and/or adsorbing hydrogen. The material is loaded with gas by exposing the material to the gas under high pressure. When the material is exposed to gas under pressure, the gas absorbs into or adsorbs onto the material. After the material is loaded with gas, the gas atmosphere and high pressure are maintained while the material is packaged in a sealed container that is capable of retaining the high pressure gas. In one embodiment, the material may be loaded with gas in a cryogenically cooled environment. In one embodiment, after the material is loaded with gas at or near a cryogenic temperature, the material loaded with gas is sealed within a cryogenically cooled container configured to maintain its contents at a cryogenic temperature. As used herein, the term “cryogenic temperature” is defined as any temperature below 93 K, this definition being consistent with the standards used by the U.S. National Institute of Standards and Technology.

In the following description, an exemplary embodiment is described for loading a solid material such as palladium with hydrogen gas. Those skilled in the art will appreciate that similar procedures may be used for loading the solid material with other gases.

The main functional components of the gas-loading and packaging system 10 comprise a gas source 12, rough/backing pump 15, turbo-molecular pump 17, sample loading chamber 20, process chamber 40, and packaging chamber 60. The gas source 12 connects via gas supply line 14 to the sample loading chamber 20, process chamber 40, and packaging chamber 60. Control valves 22, 42, and 62 control the flow of gas from the gas source 12 into the sample loading chamber 20, process chamber 40, and packaging chamber 60 respectively. The rough/backing pump 15 connects via vacuum line 16 to the sample loading chamber 20, process chamber 40, and packaging chamber 60. Control valves 24, 44, and 66 connect/disconnect the sample loading chamber 20, process chamber 40, and packaging chamber 60 respectively from the rough/backing pump 15. The turbo-molecular pump 17 connects via vacuum line 18 to the sample loading chamber 20, process chamber 40, and packaging chamber 60. Control valves 26, 46, and 64 connect/disconnect the sample loading chamber 20, process chamber 40, and packaging chamber 60 respectively from the turbo-molecular pump 17.

The sample loading chamber 20 is the point of entry where the solid material is initially introduced into the gas-loading and packaging system 10. The sample loading chamber 20 includes a door 34 through which a solid material is placed inside the sample loading chamber 20. When closed, the door 34 forms a seal that is capable of holding pressure or vacuum inside the sample loading chamber 20. A pressure gauge 28 measures the gas pressure inside the sample loading chamber 20. A linear transfer apparatus 36 is disposed inside the sample loading chamber 20 for transferring the solid material from the sample loading chamber 20 to the process chamber 40 as hereinafter described in greater detail.

The sample loading chamber 20 is connected to the process chamber 40 by a sealed passageway 30 including a gate valve 32 for isolating the sample loading chamber from the process chamber 40, and vice versa. The passageway 30 and gate valve 32 are sized to allow the transfer of the solid material from the sample loading chamber 20 to the process chamber 40 while maintaining the gas atmosphere and high gas pressure.

The process chamber 40 is where the solid material is exposed to and loaded with hydrogen gas. A pressure gauge 48 measures the gas pressure inside the process chamber 40. A scale 54 inside the process chamber 40 continuously measures the mass of the solid material while the solid material is in the process of being loaded with hydrogen gas. As described in more detail below, the measurements of the mass of the solid material are used to determine when the solid material is loaded with a desired amount of hydrogen gas. Measurements of the mass of the solid material may be made when the solid material is initially placed in the process chamber 40 to determine the starting mass of the solid material and at predetermined or periodic time intervals during the loading of gas into the solid material to determine the change in mass of the solid material. The measurements may continue until the predetermined amount of gas is loaded into the solid material.

The process chamber 40 is connected to the packaging chamber 60 by a sealed passageway 50 including a gate valve 52 for isolating the process chamber 40 from the packaging chamber 60, and vice versa. The passageway 50 and gate valve 52 are sized to allow the transfer of the solid material from the process chamber 40 to the packaging chamber 60 while maintaining the gas atmosphere and high gas pressure.

The packaging chamber 60 is where the solid material loaded with hydrogen gas is packaged in a sealed container. A pressure gauge 68 measures the gas pressure inside the packaging chamber 60. The packaging chamber 60 includes a door 72 through which the sealed container containing the solid material is removed from the gas loading and packaging system 10. When closed, the door 34 forms a seal that is capable of holding pressure or vacuum inside the packaging chamber 60. A linear transfer apparatus 70 is disposed inside the packaging chamber 60. The linear transfer apparatus is used to transfer the solid material after it is loaded with hydrogen gas from the process chamber 40 to the packaging chamber 60.

The operation of the gas loading and packaging system 10 can be broken down into five processes: an intake process, a first transfer process, a gas loading process, a second transfer process, and a packaging process. During the intake process, a sample of solid material, e.g. palladium, is placed inside the sample loading chamber 20. The sample loading chamber 20 is evacuated to remove contaminants. Once the contaminants are removed, the sample loading chamber 20 is pressurized to about 760 Torr, which is one atmosphere. At this point, the intake process ends and the first transfer process begins, during which the solid material is transferred from the sample loading chamber 20 to the process chamber 40.

During the first transfer process, the pressure in the process chamber is raised to about 10 Torr to 50 Torr above the sample loading chamber pressure. The higher pressure in the process chamber 40 relative to the sample loading chamber 20 serves to minimize the flow of any contaminants from the sample loading chamber 20 to the process chamber 40 during the transfer of the solid material. The gate valve 32 isolating the sample loading chamber 20 is then opened and the linear transfer apparatus 36 transfers the sample of solid material into the process chamber 40 and places the sample on the scale 54. The linear transfer apparatus 36 may comprise a retractable arm that picks up the solid material, extends into the process chamber 40 and deposits the solid material on the scale 54, and then retracts back into the sample loading chamber 20. When the transfer of the solid material is complete, the gate valve 32 is closed. At this point, the first transfer process ends and the gas loading process begins, during which the solid material is loaded with hydrogen gas.

At the start of the hydrogen loading process, both gate valves 32 and 52 are closed to isolate the process chamber 40. The process chamber pressure is increased to a pressure in the range of about 3800 Torr to about 7600 Ton. When the solid material is exposed to hydrogen gas under high pressure, hydrogen gas is absorbed into and adsorbed onto the solid material. The amount of hydrogen gas loaded onto the solid material, by absorption and/or adsorption, is determined by the change of mass of the solid material. The change of mass of the solid material is related to the amount of hydrogen by:

$$L = \frac{Δ m}{9.50 \times {10}^{- 3} P}$$

where L is the loading ratio of atoms of hydrogen to atoms of palladium, Am is the change in mass of the palladium sample in grams, and P is the mass of the palladium sample in grams.

The mass of the solid material is continuously or periodically checked during the gas loading process to determine when the solid material is loaded with a desired amount of hydrogen gas. In one embodiment, the change of mass is calculated and compared to a pre-computed mass change threshold to determine when the solid material is loaded with a desired amount of hydrogen gas. In other embodiments, the amount of hydrogen gas loaded onto the solid material is computed according to Equation 1. The gas loading process ends when the change of mass reaches the threshold, or when the calculated amount of hydrogen gas loaded onto the solid material equals the desired amount.

Once the solid material is loaded with a desired amount of hydrogen gas, the second transfer process begins. During the second transfer process, the pressure inside the packaging chamber is raised to about 10 Torr to about 50 Torr below the process chamber pressure and the gate valve 52 is opened. The lower pressurization of the packaging chamber 60 relative to the process chamber 40 serves to minimize the flow of any contaminants from the packaging chamber 60 to the process chamber 40 since the packaging chamber 60 is opened to the atmosphere to remove the sample. The linear transfer apparatus 70 in the packaging chamber 60 transfers the solid material loaded with hydrogen gas from the process chamber 40 into the packaging 60. The linear transfer apparatus 70 may comprise a retractable arm that extends into the process chamber 40, picks up the solid material, and then retracts back into the packaging chamber 60. After the solid material is transferred into the packaging chamber 60, the gate valve 52 is closed to isolate the packaging chamber 60. At this point the second transfer process ends and the packaging process begins.

It is assumed that a sealed container is placed inside the packaging chamber 60 prior to the start of the packaging process. The sealed container may be introduced into the packaging chamber 60 anytime before the start of the second transfer process. Prior to the start of the packaging process, the packaging chamber 60 may be evacuated to remove contaminants. In one embodiment, the packaging chamber 60 is outfitted with vacuum/high pressure mechanical arms or other accessories as needed to transfer the solid material sample into a container that is capable of maintaining the process gas at the process pressure. In another embodiment, the packaging chamber 60 may comprise a glove box that enables a human user to handle and package the solid material. After sealing the container, the packaging chamber 60 may be evacuated to atmospheric pressure, nominally 760 Torr (101 kPa). The door 72 to the packaging chamber 60 is then opened and the packaged solid material sample is removed. The packaging enables the solid material sample to maintain the incorporated gas, maximizing its usefulness in application and longevity.

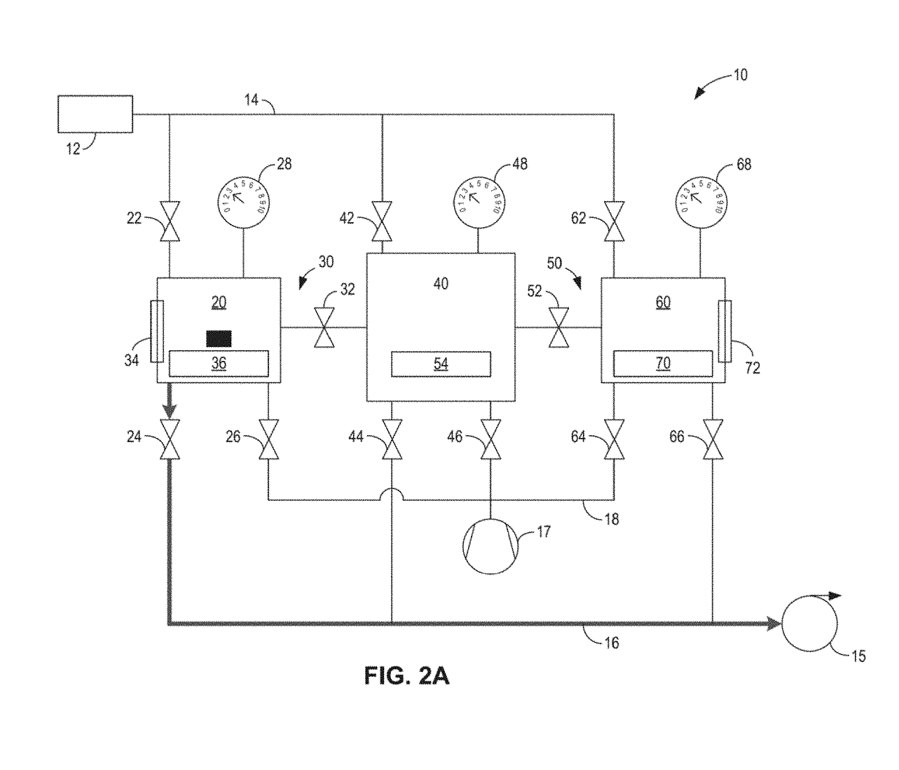

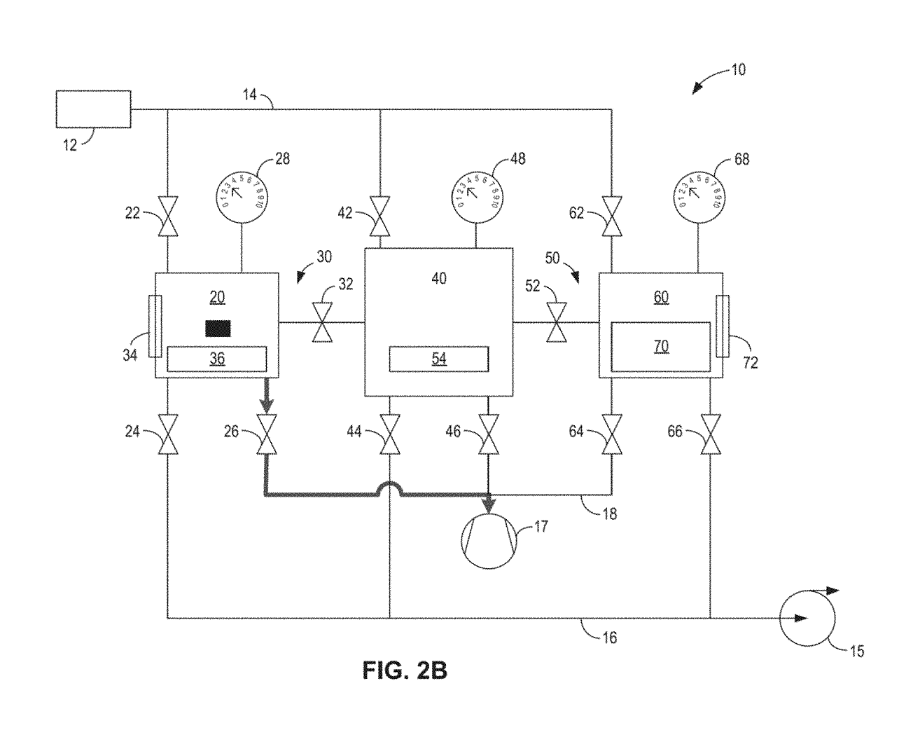

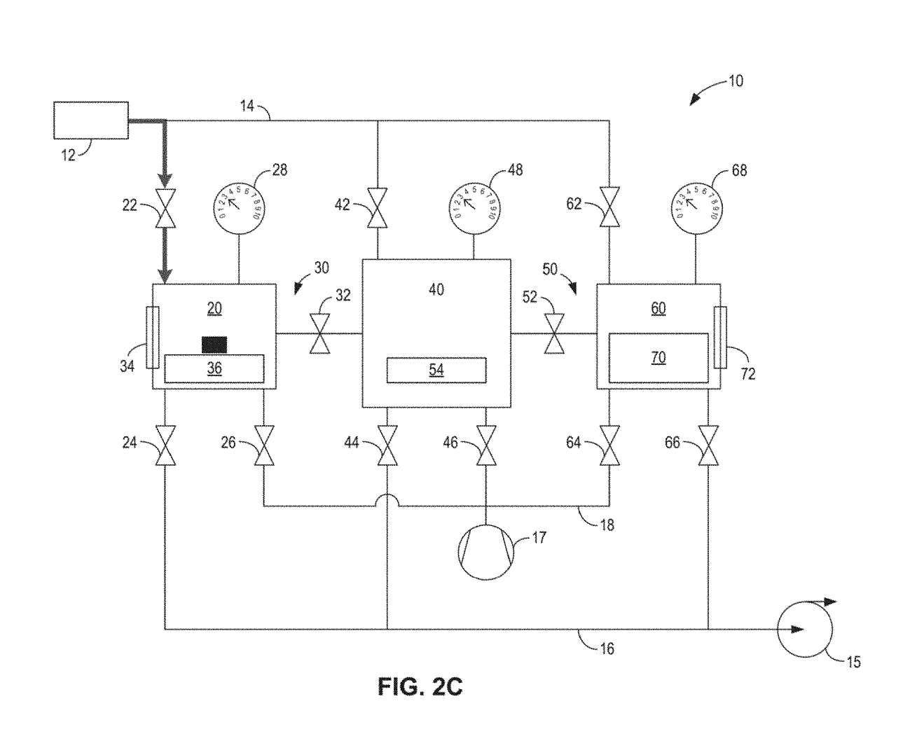

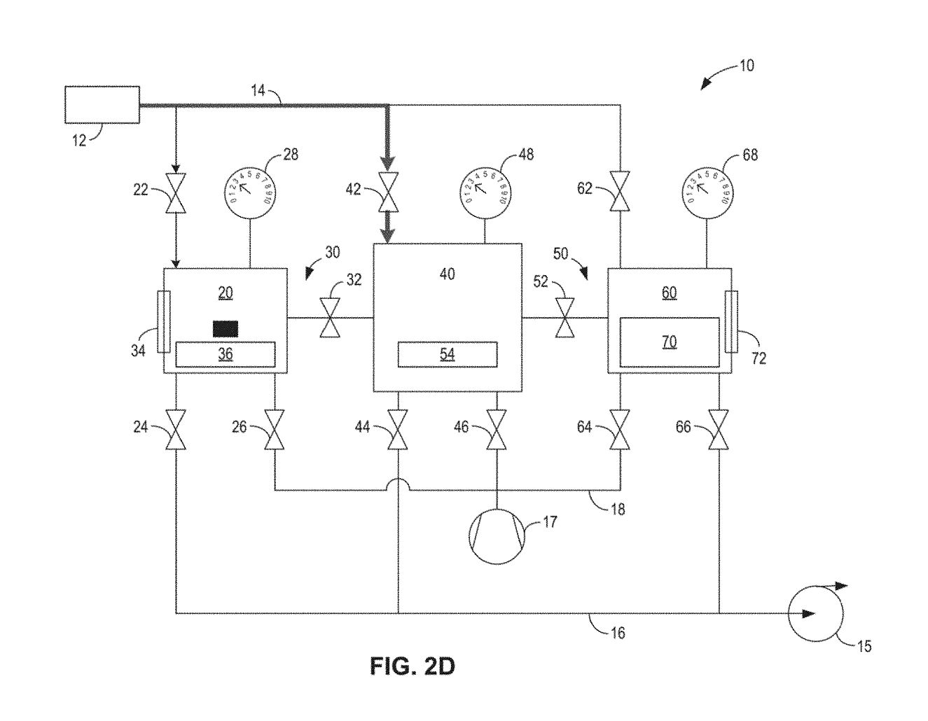

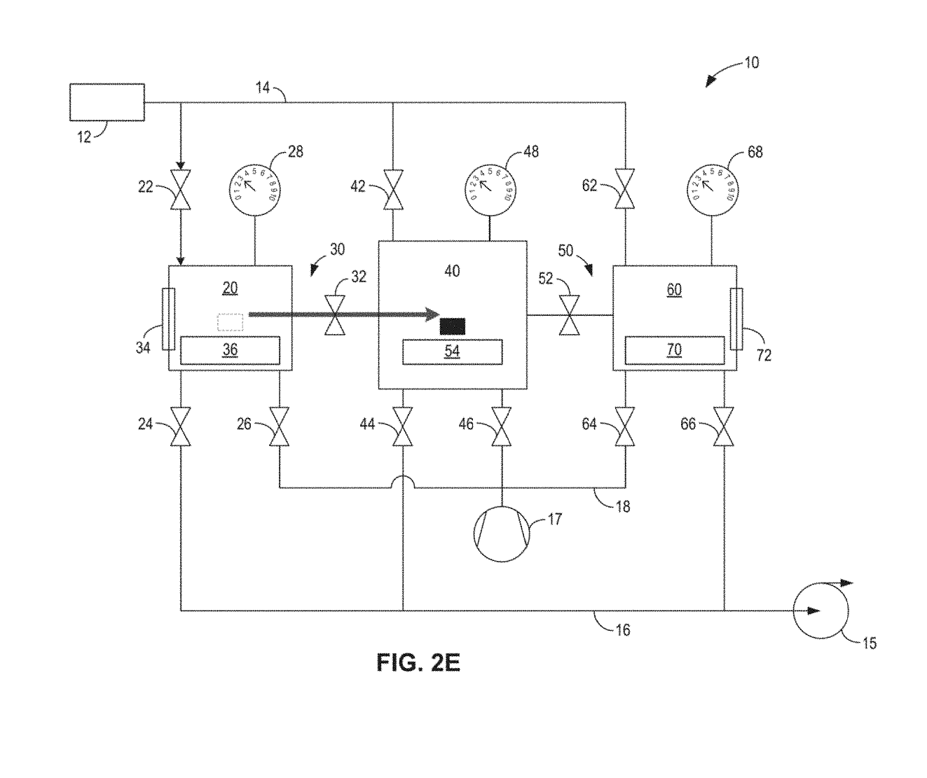

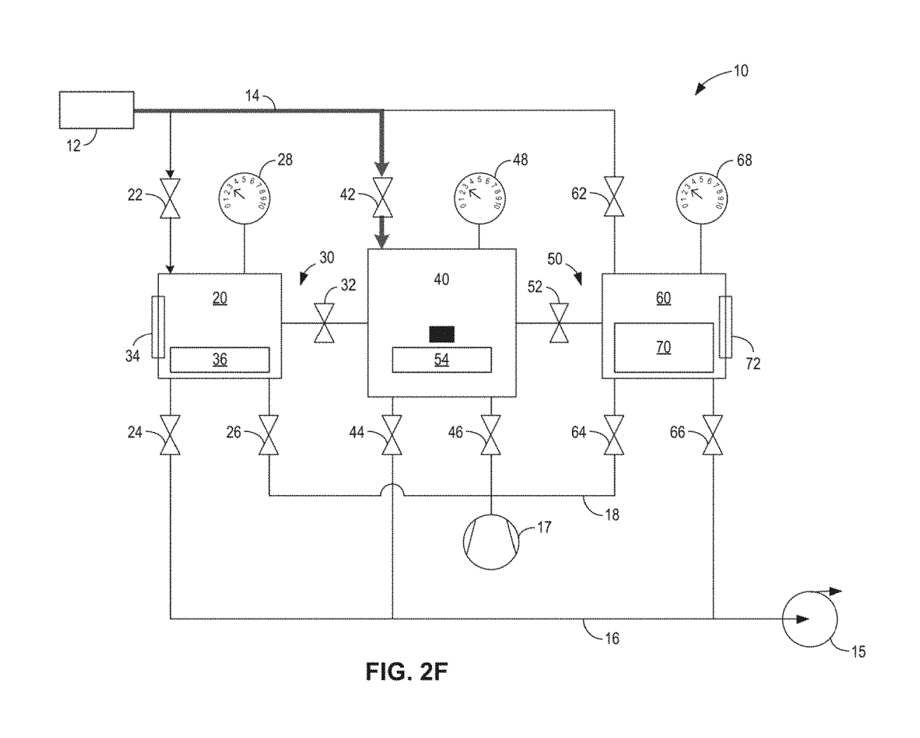

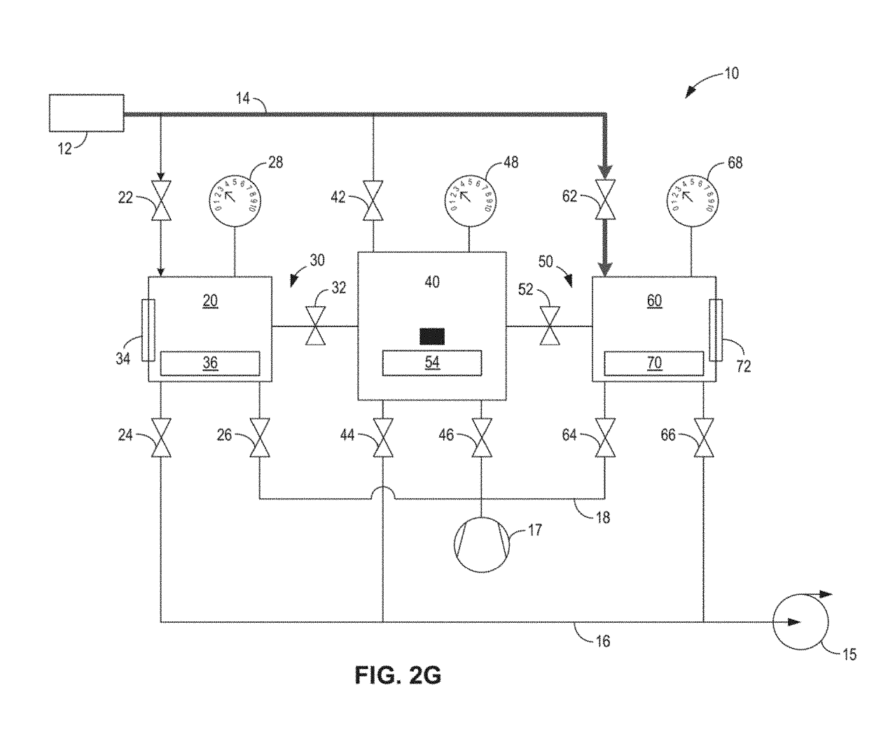

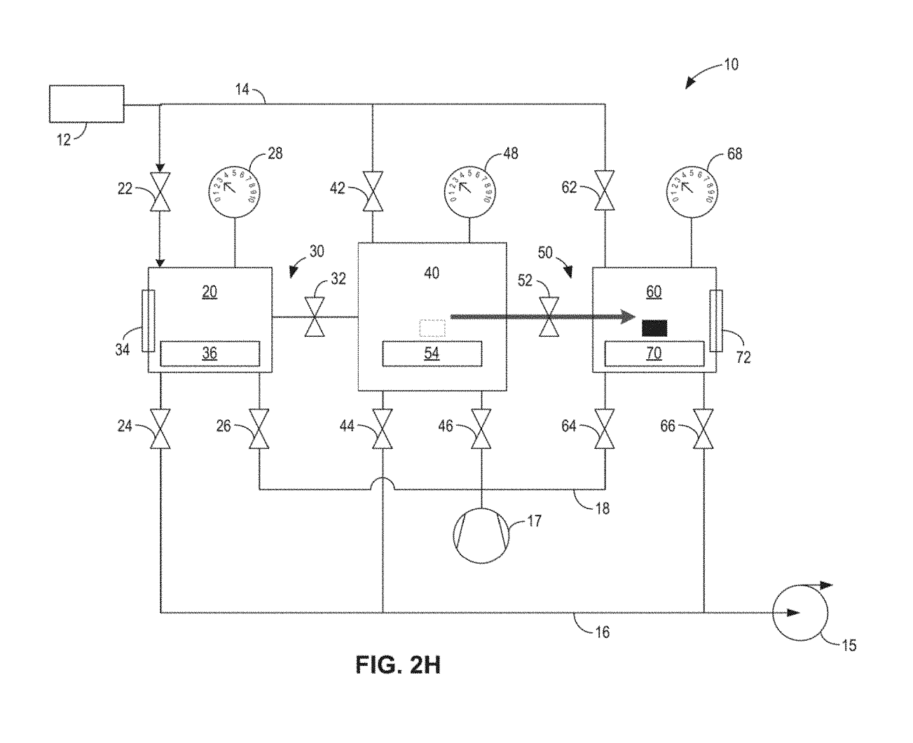

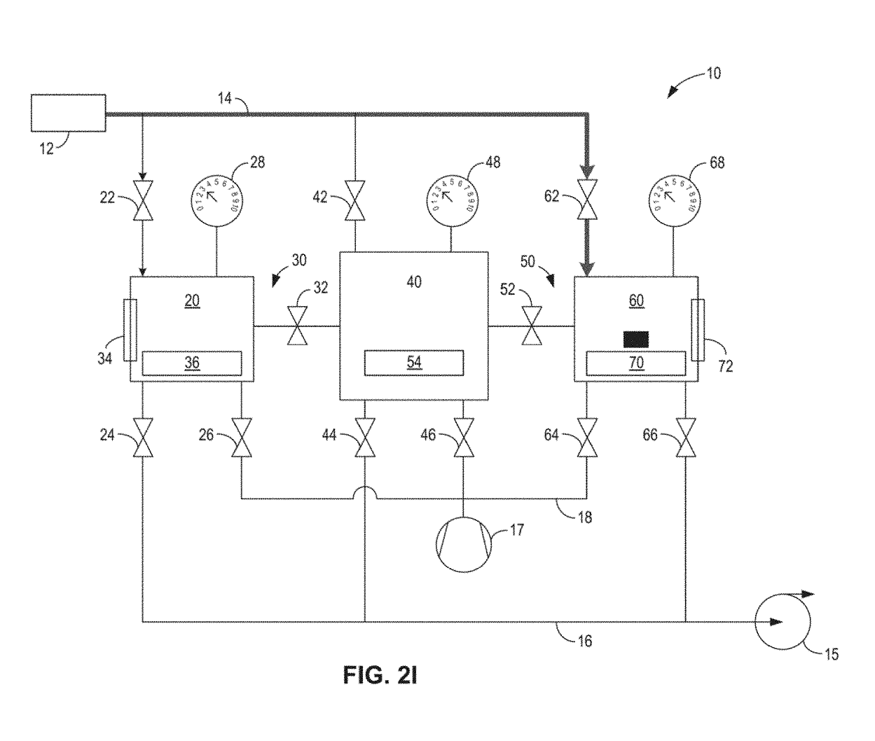

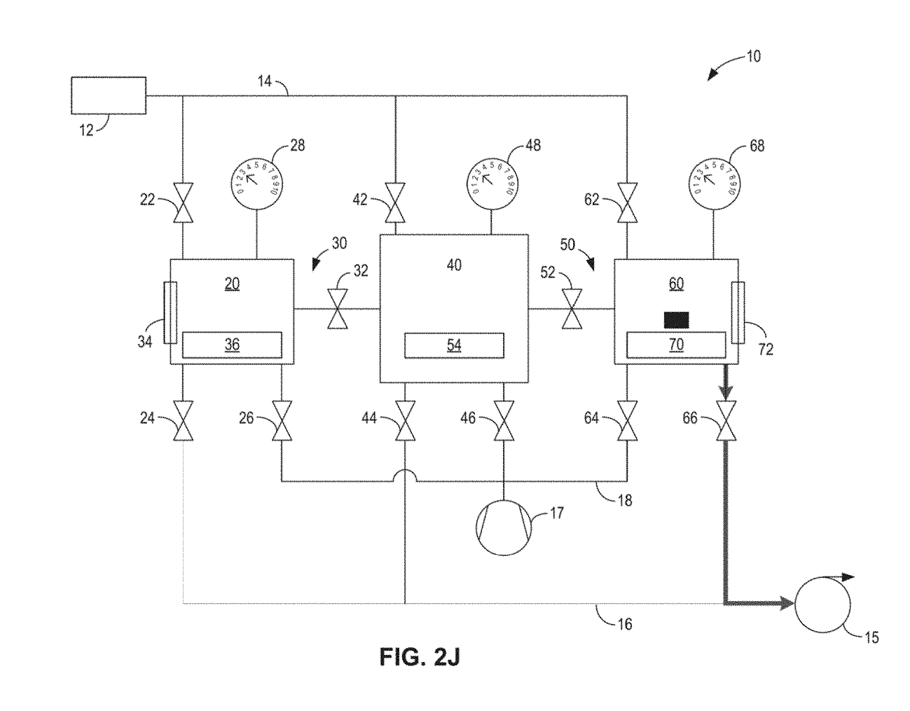

The following is a more detailed, step-by-step description of the gas loading and packaging process. FIGS. 2A-2J illustrate some of these steps.
1. Load a solid material sample into the sample loading chamber and seal the sample loading chamber 20.
2. Open valve 24 to connect the sample loading chamber 20 to rough/backing pump 15 and begin evacuation of the sample loading chamber 20 as shown in FIG. 2A.
3. When the pressure level in sample loading chamber 20 reaches approximately 0.1 Torr (13 Pa), close valve 24 and open valve 26 to connect the sample loading chamber 20 to turbo-molecular pump 17 and continue evacuation of the sample loading chamber 20 as shown in FIG. 2B.
4. When the pressure level in sample loading chamber 20 reaches approximately 1×10⁻⁶ Torr (1×10⁻⁴ Pa), close valve 26.
5. Open valve 22 to connect the sample loading chamber 20 to gas source 12 and fill the sample loading chamber 20 with the hydrogen gas as shown in FIG. 2C. The pressure inside the sample loading chamber 20 is measured by the pressure gauge 28.
6. Continue adding gas until the pressure in the sample loading chamber 20 reaches nominally 760 Torr (101 kPa), which is the working pressure of the sample loading chamber 20 reached. Shut off valve 22 when the pressure reaches the working pressure. This step ends the intake process.
7. Begin the first transfer process by opening valve 42 to add process gas to the process chamber 40 as shown in FIG. 2D. Continue adding hydrogen gas until the pressure inside the process chamber 40 reaches between 10 and 50 Torr (1.3 and 6.7 kPa) greater than the sample loading chamber pressure.
8. Close valve 42 and open gate valve 32 connecting the sample loading chamber 20 to the process chamber 40. The higher pressure level of the process chamber 40 relative to the sample loading chamber 20 serves to minimize the flow of any contaminants from the sample loading chamber 20 to the process chamber 40.
9. Transfer the solid material sample from the sample loading chamber 20 to the process chamber 40 and place the solid material sample on the scale 54 as shown in FIG. 2E.
10. Close gate valve 32 when the transfer of the solid material sample to the process chamber 40 is completed.
11. If it is desirable or required to increase the process gas pressure for adsorption on and absorption into the solid material sample, open valve 42 to increase the process gas pressure up to nominally 3800 Torr (507 kPa) to about 7600 Ton (1014 kPa) as shown in FIG. 2F. The sample will be loaded with hydrogen gas by absorption and adsorption. The amount of gas adsorbed and absorbed is calculated from the mass change measured by the scale after correcting for a change in chamber pressure.
12. During the gas-loading process, periodically measure the mass of the solid material sample and calculate the mass change of the solid material sample. Continue gas-loading until a desired amount of gas is added to the solid material sample. When the mass change and/or the solid material sample is loaded with a desired amount of gas, start the second transfer process to transfer the solid material sample to the packaging chamber 60.
13. To start the second transfer process, open valve 62 to supply gas to the process packaging chamber 60 as shown in FIG. 2G. Continue supplying gas to the packaging chamber 60 until the gas pressure in the packaging chamber 60, indicated by pressure gauge 68, is between 10 and 50 Torr (1.3 and 6.7 kPa) lower than the process chamber 40 pressure indicated by pressure gauge 48, at which time valve 62 is closed. The lower pressurization of the packaging chamber 60 relative to the process chamber 40 serves to minimize the flow of any contaminants from the packaging chamber 60 to the process chamber 40 since the packaging chamber 60 is opened to atmosphere to remove the sample. 14. Open gate valve 52 and transfer the solid material sample from the process chamber 40 to the packaging chamber 60 using the second linear transfer apparatus 70 as shown in FIG. 2H. When the transfer of the metal sample to the packaging chamber 60 is complete, close gate valve 52 to isolate the packaging chamber 60. This step ends the second transfer process.
15. In some cases, it may be desirable to increase the pressure in the packaging chamber 60 at the start of the packaging process. In this case, open valve 62 as shown in FIG. 21 to pressurize the packaging chamber 60 to a desired pressure level above the processing pressure to maintain the loading of the solid material sample.
16. Package solid material sample into a pressure sealed container. The packaging chamber 60 may be outfitted with vacuum/high pressure mechanical arms or other accessories as needed to transfer the solid material sample into a container that is capable of maintaining the process gas at the process pressure.
17. After sealing the container, open valve 66 to evacuate the packaging chamber 60 to atmospheric pressure, nominally 760 Torr (101 kPa) a shown in FIG. 2J.
18. Open the packaging chamber 60 and remove the packaged solid material sample.

The packaging enables the solid material sample to maintain the incorporated gas—maximizing its usefulness in application and longevity.

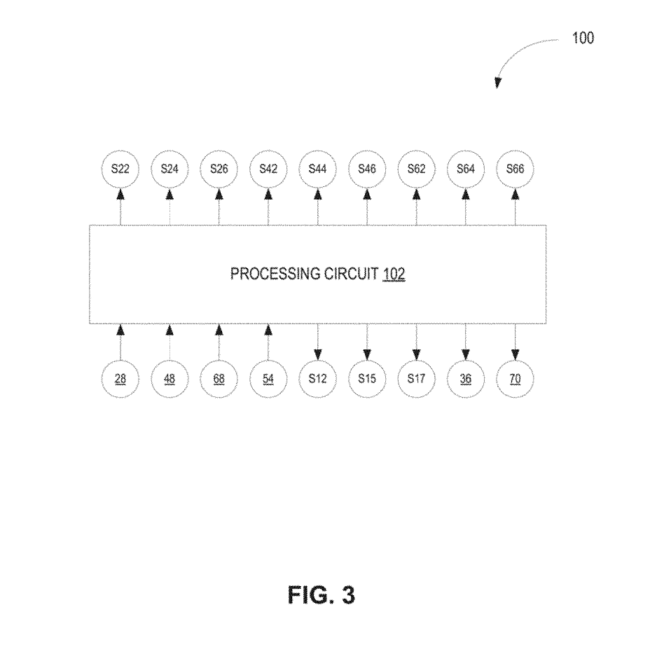

FIG. 3 illustrates an exemplary control circuit 100 for controlling the operation of the gas loading and packaging system 10. The control circuit 100 comprises a processing circuit 102 that implements the main control functions of the gas loading and packaging system 10. The processing circuit 102 may comprise one or more processors, hardware circuits, firmware, of a combination thereof. The processing circuit 102 receives inputs from the pressure gauges 28, 48, and 68, and the scale 54 and outputs control signals to various solenoids and switches that control the valves as hereinabove described. Solenoids or switches S22, S24, S26, S42, S44, S46, S62,S64, and S66 control valves 22, 24, 26, 42, 44, 46, 62, 64, and 66 respectively. Solenoids or switches S32 and S52 control gate valves 32 and 52 respectively. Solenoids or switches S12, S15 and S17 control the gas source 12, rough/backing pump 15, and turbo-molecular pump 17 respectively. The processing circuit 102 may also send control signals to the linear transfer apparatus 36 and 70.

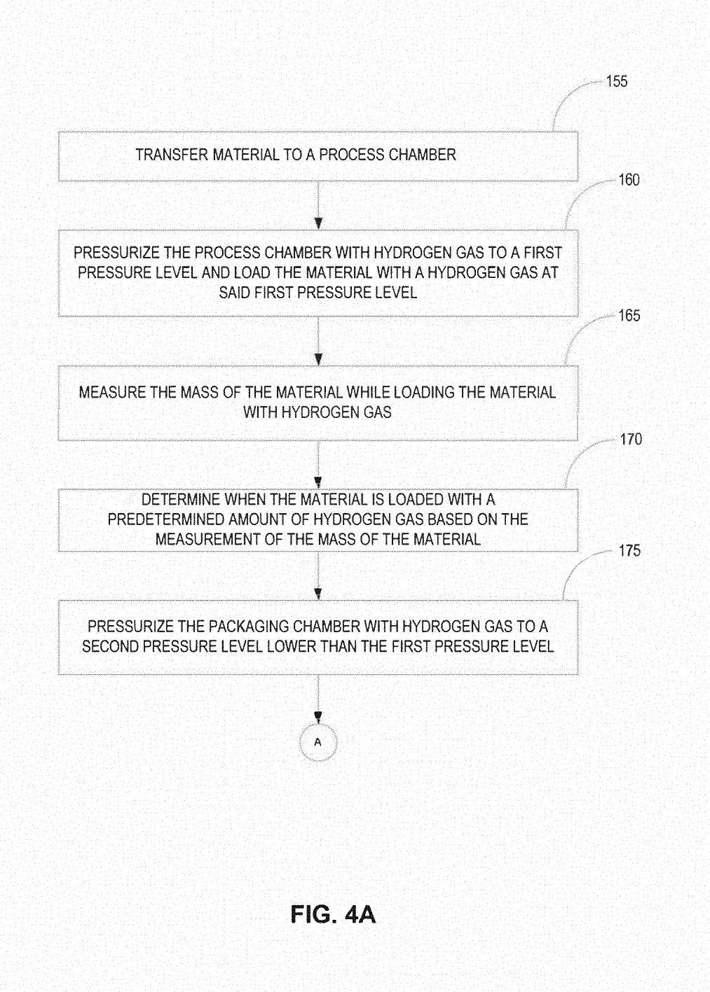

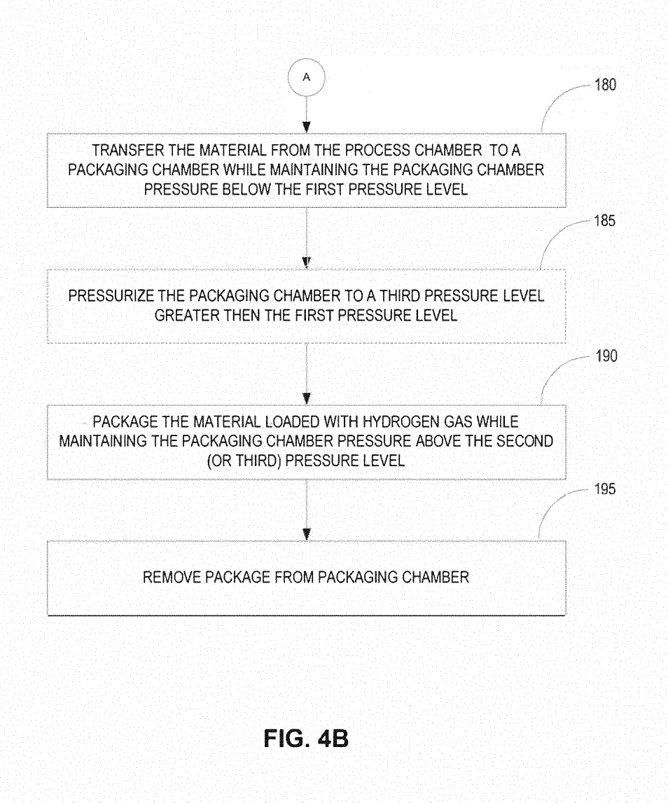

FIGS. 4A and 4B illustrate an exemplary method 150 of gas loading and packaging a solid material. The solid material is transferred to a process chamber 40 (block 155). Once the solid material is loaded in to the process chamber 40, the process chamber 40 is pressurized with hydrogen gas until the process chamber pressure reaches a first pressure level (block 160). The process chamber pressure is maintained above the first pressure level to load the solid material with hydrogen gas. While the solid material is being loaded with hydrogen gas, the mass of the solid material is measured and the measurements are used to determine when the solid material is loaded with a predetermined amount of hydrogen gas based (blocks 165 and 170). When the desired amount of hydrogen gas is loaded into the solid material, pressurize the packaging chamber 60 with hydrogen gas until the packaging chamber pressure reaches a second pressure level lower than the first predetermined pressure level and transfer the solid material from the process chamber to the packaging chamber (blocks 175 and 180) The solid material is then packaged in a sealed container while maintaining the packaging chamber pressure at or above second pressure level, after which the sample chamber is opened and the sealed container is removed from the packaging chamber 60 (blocks 190 and 195). In some embodiments, the packaging chamber pressure may be raised to a third pressure level higher than the first pressure level while the solid material is packaged (block 185).

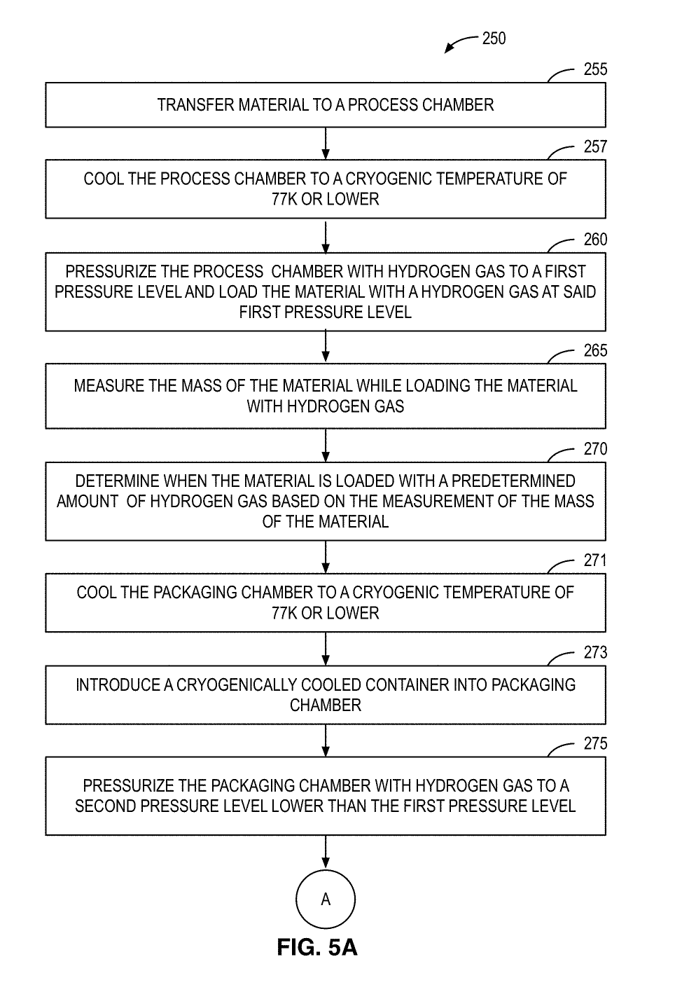

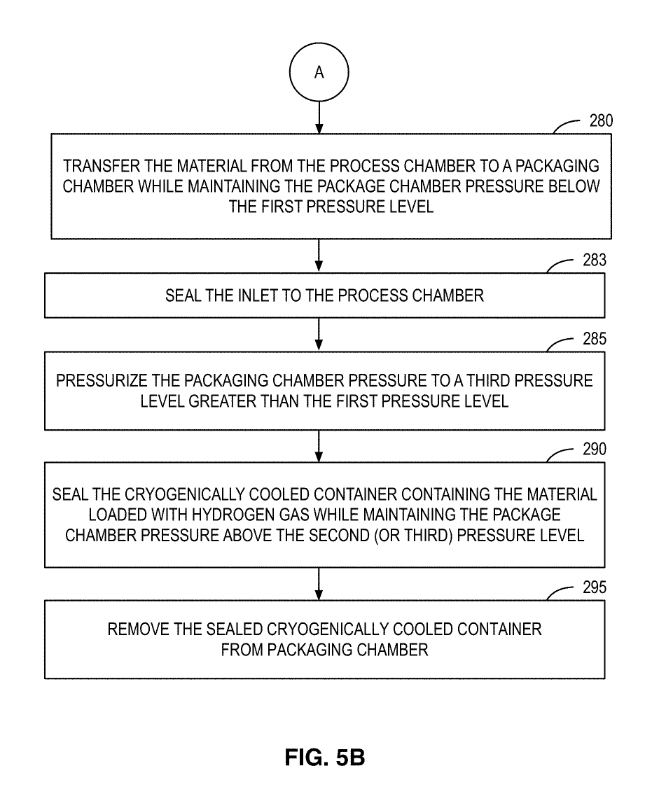

FIGS. 5A and 5B illustrate an exemplary method 250 of gas loading and packaging a material within a cryogenically cooled container in a cryogenically cooled environment. In one embodiment, the material may in solid state. In another embodiment, the material may be in liquid state. The material to be loaded with gas is transferred to process chamber 40 (block 255). Once the material is loaded in to the process chamber 40, the process chamber 40 is cooled to a cryogenic temperature of about 77 Kelvin or to some other specified cryogenic temperature (block 257). In an alternate embodiment, the process chamber is cooled to a cryogenic temperature of about 93 K or lower. In another embodiment, the process chamber 40 is cooled to a cryogenic temperature of 77 Kelvin or to some other specified cryogenic temperature prior to the material being loaded into the process chamber 40. Once the process chamber 40 is cooled to a cryogenic temperature, the process chamber 40 is pressurized with hydrogen gas until the process chamber pressure reaches a first pressure level (block 260). The process chamber pressure is maintained above the first pressure level to load the material with hydrogen gas. While the material is being loaded with hydrogen gas, the mass of the material is measured and the measurements are used to determine when the material is loaded with a predetermined amount of hydrogen gas based (blocks 265 and 270). The packaging chamber 60 is cooled to a cryogenic temperature of about 77 Kelvin or lower (block 271) or to some other specified cryogenic temperature, such as, for example, about 93K or lower. A cryogenically cooled container is placed inside the packaging chamber 60 to receive the material (block 271). When the desired amount of hydrogen gas is loaded into the material, pressurize the packaging chamber 60 with hydrogen gas until the packaging chamber pressure reaches a second pressure level lower than the first predetermined pressure level (block 275). Transfer the material from the process chamber 40 to the cryogenically cooled container placed inside the packaging chamber 60 while maintaining the package chamber pressure below the first pressure level (block 280). Seal the inlet to the process chamber after transferring the material from the process chamber to the cryogenically cooled container placed inside the packaging chamber 60 (block 283); that is, seal the first passageway after the material is received within a cryogenically cooled container placed in the packaging chamber 60. Then, seal the cryogenically cooled container containing the material while maintaining the packaging chamber pressure at or above second pressure level; after this, open the packaging chamber 60 and remove the sealed cryogenically cooled container from the packaging chamber 60 (blocks 290 and 295). In some embodiments, the packaging chamber pressure may be raised to a third pressure level higher than the first pressure level while the material is packaged (block 285).

The cryogenic cooling mechanism and the cryogenically cooled container will now be explained in detail. In physics, cryogenics is the production and behavior of materials at very low temperatures. It is not well-defined at what point on the temperature scale refrigeration ends and cryogenics begins. The U.S. National Institute of Standards and Technology has chosen to consider the field of cryogenics as that involving temperatures below −180° C. (93 K; −292° F.). This is a logical dividing line, since the normal boiling points of the so-called permanent gases (such as helium, hydrogen, neon, nitrogen, oxygen, and normal air) lie below −180° C. while the Freon refrigerants, hydrocarbons, and other common refrigerants have boiling points above −180° C. To the contrary, some scientists assume a gas to be cryogenic if it can be liquefied at or below −150° C. (123 K; −238° F.). As used herein, the term “cryogenic temperature” is defined as any temperature below 93 K, this definition being consistent with the standards used by the U.S. National Institute of Standards and Technology.

Liquefied gases, such as, for e.g., liquid nitrogen and liquid helium, are used to generate cryogenic temperatures. Liquid nitrogen is the most commonly used element in cryogenics. Liquid helium is also commonly used, and it allows for the lowest attainable temperatures to be reached. These liquefied gases can be stored in Dewar flasks, which are double-walled containers with a high vacuum between the walls to reduce heat transfer into the liquid. Typical laboratory Dewar flasks are spherical, made of glass and protected in a metal outer container. Dewar flasks for extremely cold liquids such as liquid helium have another double-walled container filled with liquid nitrogen. Often, cryogenic barcode labels are used to mark Dewar flasks containing these liquids. The Dewar flasks typically will not frost over down to −195 degrees Celsius.

Cryogenic cooling of materials is usually achieved via the use of liquid nitrogen or liquid helium. Cryogenic cooling can also be achieved via a mechanical cryocooler, which uses high pressure helium lines. As is well-known in the cryogenics art, Gifford-McMahon cryocoolers, pulse tube cryocoolers, and Stirling cryocoolers are in wide use with the selection of a particular cryocooler dependent on required base temperature and cooling capacity. The most recent development in cryogenics is the use of magnets as regenerators as well as refrigerators, wherein these devices work on the principle known as the magnetocaloric effect. Further, cryogenic transfer pumps and cryogenic valves are also available in the market, for use in e.g., liquefied natural gas applications.

In one embodiment, a cryocooler mechanism comprising high pressure helium lines is provided for cooling the sample loading chamber 20, the process chamber 40, the packaging chamber 60, and other relevant components of the packaging system 10 to facilitate efficient gas-loading operations of a material at cryogenic temperatures. In one embodiment, the sample loading chamber 20, the process chamber 40, and the packaging chamber 60 are serviced by helium supply and discharge conduits/lines that circulate helium at high pressure to and from a cryocooler central cooling unit. In another embodiment, only the process chamber 40 and the packaging chamber 60 are connected to, and cooled by, a cryocooler central cooling unit, but not the sample loading chamber 20. In an alternate embodiment, liquid nitrogen represents the cryogenic cooling medium.

Cryogenic cooled containers as described herein may be a Dewar flask in one embodiment. In another embodiment, the cryogenic cooled container may be commercially available vacuum container by tradename “Dry Vapor Shipper” manufactured by Cryoport. The vacuum container that generates the cold guarantees constant cooling of −150 degrees Celsius over a period of up to ten days without any interim controls. Storage and transportation may be accomplished a shipping unit comprising dry ice and liquid nitrogen. A rubber gasket between the glass bottle and lid makes for air-tight closure. The Cryoport product may further comprise the ability to monitor, save and track time and temperature curves in real time by integrating a data logger that further offers an intervention option.

Generally, hydrogen is stored on the surfaces of solids (by adsorption) or within solids (by absorption). In adsorption, hydrogen is attached to the surface of a material either as hydrogen molecules or as hydrogen atoms. In absorption, hydrogen is dissociated into H-atoms, and then the hydrogen atoms are incorporated into the solid lattice framework. However, Hydrogen can also be stored through the reaction of hydrogen-containing materials with water (or other compounds such as alcohols). In this case, the hydrogen is effectively stored in both the material and in the water. The term “chemical hydrogen storage” or chemical hydrides is used to describe this form of hydrogen storage. Hydrogen can thus be stored in the chemical structures of liquids. In embodiment, the liquid material onto which hydrogen is loaded may represent an alcohol, for example.

In the following description, an exemplary embodiment for loading a solid or liquid material with hydrogen gas involving cryogenic cooling will be described. Those skilled in the art will appreciate that similar procedures may be used for loading the material with other gases. The gas-loading and packaging apparatus and system for loading a material with hydrogen gas involving cryogenic cooling will, in addition to the components shown in FIG. 1, include a cryocooler mechanism provided for cooling at least the sample loading chamber 20, the process chamber 40, and the packaging chamber 60 to cryogenic temperatures to facilitate efficient gas-loading of the material at cryogenic temperatures. In one embodiment, the material being subjected to cryogenic cooling may represent a solid material. The cryocooler mechanism may be configured with valves and conduits/lines carrying a liquefied gas (for e.g., liquefied helium or liquefied nitrogen) for cooling (i.e., removing heat) from the sample loading chamber 20, the process chamber 40, and/or the packaging chamber 60. In one embodiment, the cryocooler mechanism includes separate set of conduits /lines, valves and temperature controls for each of the sample loading chamber 20, process chamber 40, and packaging chamber 60. Further, separate controls may be provided for connecting/disconnecting each of the sample loading chamber 20, process chamber 40, and packaging chamber 60 from the cryocooler mechanism. In one embodiment, each of the sample loading chamber 20, process chamber 40, and packaging chamber 60 is connected by a supply conduit/line and a return conduit/line connecting each of the respective chambers to the cryocooler mechanism; in this embodiment, each of the supply and return conduits/line are provided with its own control valves in order to individually control the cryogenic cooling process as well as the resulting cryogenic temperature in each of the sample loading chamber 20, process chamber 40, and packaging chamber 60 . The conduits/lines operate to absorb heat from each of the sample loading chamber 20, process chamber 40, and packaging chamber 60 in order to lower the temperature to the cryogenic temperature range. In one embodiment, the cryocooler mechanism is configured to lower the temperature of each of the sample loading chamber 20, process chamber 40, and packaging chamber 60 to 77 K or lower. In another embodiment, the cryocooler mechanism is configured to lower the temperature of each of the sample loading chamber 20, process chamber 40, and packaging chamber 60 to about 93 K or lower (93 K representing the threshold of cryogenic cooling as defined herein).

In the embodiment that includes the cryogenic cooling mechanism, every component of the system 10 that is or may be exposed to the cryogenic temperatures is constructed such that it can withstand the low temperatures associated with cryogenic cooling. For example, the door 34 forming a seal that is capable of holding pressure or vacuum inside the sample loading chamber 20 may further be capable of providing thermal insulation thereby holding the cryogenic temperature inside the sample loading chamber 20. A temperature gauge measures the temperature inside the sample loading chamber 20. Further, the linear transfer apparatus 36 for transferring the material from the sample loading chamber 20 to the process chamber 40 is configured for handling the material cooled to a cryogenic temperature. The passageway 30 and gate valve 32 are sized to allow the transfer of the material from the sample loading chamber 20 to the process chamber 40 while maintaining the cryogenic temperature of the material. Further, a temperature gauge measures temperature inside the process chamber 40. As described earlier, the measurements of the mass of the material are used to determine when the material is loaded with a desired amount of hydrogen gas. Measurements of the mass of the material may be made when the material is initially placed in the process chamber 40 to determine the starting mass of the material and at predetermined or periodic time intervals during the loading of gas into the material to determine the change in mass of the material. The measurements may continue until the predetermined amount of gas is loaded into the material while the material as well as the ambience contiguous to the material is maintained at a cryogenic temperature by the cryogenic cooling mechanism.

The sealed passageway 50 is provided with adequate thermal insulation and is further configured to handle cryogenic temperatures. Gate valve 52 for isolating the process chamber 40 from the packaging chamber 60, and vice versa is provided with capability to completely sealing, including thermally sealing, the inlet side of the process chamber 40.

The packaging chamber 60 is where the material loaded with hydrogen gas is packaged in a cryogenically cooled container and sealed. A temperature gauge is provided for measuring the temperature inside the packaging chamber 60. The packaging chamber 60 includes a door 72 through which the sealed cryogenically cooled container (containing the material loaded with hydrogen) is removed from the gas loading and packaging system 10. When closed, the door 72 forms a seal that is capable of maintaining cryogenic temperature within the packaging chamber 60. A linear transfer apparatus 70 disposed inside the packaging chamber 60 is used to transfer the cryogenically cooled container after it is loaded with the material with hydrogen gas from the packaging chamber 60 to the outside of the system 10.

The operation of the gas loading and packaging system 10 associated with the apparatus/method that includes the cryogenic cooling mechanism is otherwise similar to the apparatus/method that does not include the cryogenic cooling mechanism. For example, the operation of the gas loading and packaging system 10 for the embodiment that includes the cryogenic cooling mechanism may be broken down into five processes: an intake process, a first transfer process, a gas loading process, a second transfer process, and a packaging process.

During the intake process, a sample of material, e.g., a zeolite, is placed inside the sample loading chamber 20. As is well-known in the relevant art, zeolites are metal organic type structures well-suited for hydrogen storage, especially at lower temperatures, such as cryogenic temperatures. While zeolites manifest good hydrogen loading at room temperature at elevated pressures, they manifest a much higher loading at 77K than at room temperature.

In one embodiment, the zeolite represents Zn₄O(BDC)₃, where BDC²⁻=1,4-benzenedicarboxylate (MOF-5). The structure of zeolite MOF-5 includes square openings that are either 13.8 or 9.2 Å depending on the orientation of the aromatic rings. MOF-5 has a hydrogen storage capacity of 7.1 wt % at 77 K and 40 bar, and of 10 wt % at 100 bar. In other words, at cryogenic temperatures, the hydrogen storage capacity of MOF-5 increases with increase in pressure. MOF-5 further has a volumetric hydrogen storage density of 66 g/L. MOF-5 has received much attention because of the partial charges on the MOF surface, which provide a means of strengthening the binding hydrogen through dipole-induced intermolecular interactions. MOF-5 has low volumetric storage density at room temperature (9.1 g/L at 100 bar).

In another embodiment, the zeolite is Mn₃[(Mn₄Cl)₃(BTT)₈]₂, where H₃BTT=benzene-1,3,5-tris(1H-tetrazole). The structure of this MOF consists of truncated octahedral cages that share square faces, leading to pores of about 10 Å in diameter; it further contains open Mn²⁺ coordination sites. It has a hydrogen storage capacity of 60 g/L at 77 K and 90 bar, and of 12.1 g/L at 298 K and 90 bar. This MOF includes open metal coordination sites thereby increasing strength of hydrogen adsorption, which results in improved performance at 298 K. It has relatively strong metal-hydrogen interactions, attributed to a spin state change upon binding or to a classical Coulombic attraction.

In one embodiment, the cryocooler mechanism in connection with the process chamber 40 cools the process chamber 40 to a cryogenic temperature of 77K or lower following which the material to be loaded with gas, for example, a zeolite, is placed within the cryogenically cooled process chamber 40. In an alternate embodiment, the material to be loaded with gas is placed within the cryogenically cooled process chamber 40 prior to the cryocooler mechanism commencing cooling of the process chamber 40 to a cryogenic temperature of 77K or lower. As noted earlier, in one embodiment, the material to be loaded with gas may be a liquid such as, for example, an alcohol or any other suitable liquid capable of absorbing or adsorbing hydrogen.

After sample of material, e.g. zeolite, is placed inside the sample loading chamber 20, the sample loading chamber 20 is evacuated to remove contaminants. Once the contaminants are removed, the sample loading chamber 20 is pressurized to about 760 Torr, which is one atmosphere. At this point, the intake process ends and the first transfer process begins, during which the material is transferred from the sample loading chamber 20 to the process chamber 40.

During the first transfer process, the pressure in the process chamber is raised to about 10 Torr to 50 Torr above the sample loading chamber pressure. The temperature in the process chamber is lowered to about 93 K or to about 77K. The higher pressure in the process chamber 40 relative to the sample loading chamber 20 serves to minimize the flow of any contaminants from the sample loading chamber 20 to the process chamber 40 during the transfer of the material. The lower the temperature within the process chamber 40, the higher is the volumetric storage capacity of the (zeolite) material. The gate valve 32 isolating the sample loading chamber 20 is then opened and the linear transfer apparatus 36 transfers the sample of material into the process chamber 40 and places the sample on the scale 54. The linear transfer apparatus 36 may comprise a retractable arm that picks up the material, extends into the process chamber 40 and deposits the material on the scale 54, and then retracts back into the sample loading chamber 20. When the transfer of the material is complete, the gate valve 32 is closed. At this point, the first transfer process ends and the gas loading process begins, during which the material is loaded with hydrogen gas.

At the start of the hydrogen loading process, both gate valves 32 and 52 are closed to isolate the process chamber 40. The process chamber pressure is increased to a pressure in the range of about 3800 Torr to about 7600 Ton, and the temperature is lowered to or maintained at about 77K or at about 93K. When the material is exposed to hydrogen gas under high pressure, hydrogen gas is absorbed into and adsorbed onto the material. The amount of hydrogen gas loaded onto the material, by absorption and/or adsorption, is determined by the change of mass of the material. The change of mass of the material is related to the amount of hydrogen by:

$$L = \frac{Δ m}{9.50 \times {10}^{- 3} P}$$

where L is the loading ratio of atoms of hydrogen to atoms of palladium, Δm is the change in mass of the palladium sample in grams, and P is the mass of the palladium sample in grams.

The mass of the material is continuously or periodically checked during the gas loading process to determine when the material is loaded with a desired amount of hydrogen gas. In one embodiment, the change of mass is calculated and compared to a pre-computed mass change threshold to determine when the material is loaded with a desired amount of hydrogen gas. In other embodiments, the amount of hydrogen gas loaded onto the material is computed according to Equation 1. The gas loading process ends when the change of mass reaches the threshold, or when the calculated amount of hydrogen gas loaded onto the material equals the desired amount.

Once the material is loaded with a desired amount of hydrogen gas, the second transfer process begins. During the second transfer process, the pressure inside the packaging chamber is raised to about 10 Torr to about 50 Torr below the process chamber pressure and the gate valve 52 is opened. The lower pressurization of the packaging chamber 60 relative to the process chamber 40 serves to minimize the flow of any contaminants from the packaging chamber 60 to the process chamber 40 since the packaging chamber 60 is opened to the atmosphere to remove the sample. The linear transfer apparatus 70 in the packaging chamber 60 transfers the material loaded with hydrogen gas from the process chamber 40 into the packaging chamber 60. In one embodiment, the linear transfer apparatus 70 transfers the material loaded with hydrogen gas from the process chamber 40 into a cryogenically cooled container placed within the packaging chamber 60, the cryogenically cooled container configured to maintain its contents at a temperature of about 93 Kelvin or lower; in another embodiment, the cryogenically cooled container is configured to maintain its contents at a temperature of about 77 Kelvin or lower.

The linear transfer apparatus 70 may comprise a retractable arm that extends into the process chamber 40, picks up the material, and then retracts back into the packaging chamber 60. After the material is transferred into the cryogenically cooled container placed within the packaging chamber 60, the gate valve 52 is closed to isolate the packaging chamber 60. At this point the second transfer process ends and the packaging process begins.

In one embodiment, the cryogenically cooled container is placed inside the packaging chamber 60 prior to the start of the packaging process. The cryogenically cooled container may be introduced into the packaging chamber 60 any time before the start of the second transfer process. Prior to the start of the packaging process, the packaging chamber 60 may be evacuated to remove contaminants. In one embodiment, the packaging chamber 60 is outfitted with vacuum/high pressure mechanical arms or other accessories as needed to transfer the material sample into a cryogenically cooled container that is capable of maintaining the process gas at the process pressure and at the process cryogenic temperature. In another embodiment, the packaging chamber 60 may comprise a glove box that enables a human user to handle and package the material into the cryogenically cooled container. After sealing the cryogenically cooled container, the packaging chamber 60 may be evacuated to atmospheric pressure, nominally 760 Torr (101 kPa). The door 72 to the packaging chamber 60 is then opened and the packaged material sample sealed within the cryogenically cooled container is removed. The sealed cryogenically cooled container packaging enables the material sample to maintain the incorporated gas at the designated temperature, maximizing its usefulness in application and longevity.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A gas-loading and packaging apparatus comprising:
a process chamber configured to receive a material to be loaded with hydrogen gas, the process chamber cooled to a cryogenic temperature of about 93 Kelvin or lower;
a scale positioned inside the process chamber for measuring a mass of the material while the material is loaded with the hydrogen gas;
a packaging chamber connected by a first passageway to the process chamber and configured to receive the material from the process chamber through the first passageway, the packaging chamber cooled to a cryogenic temperature of about 93 Kelvin or lower;
a gas supply system including a gas source for supplying hydrogen gas under pressure to the process chamber and the packaging chamber, the gas supply system configured to:
in a loading mode, supply hydrogen gas to the process chamber to increase the process chamber pressure to a first pressure level sufficient to effect the loading of material with hydrogen gas while the material is disposed within the process chamber; and
in a first transfer mode, supply hydrogen gas to the packaging chamber to increase the packaging chamber pressure to a second pressure level lower than the first pressure level to enable transfer of the material from the process chamber to the packaging chamber.

2. The gas-loading and packaging apparatus of claim 1, further comprising:
a loading chamber connected by a second passageway to the process chamber and configured to receive the material prior to it being placed into the process chamber, the loading chamber cooled to a cryogenic temperature of about 93 Kelvin or lower; and
a vacuum pump for evacuating the loading chamber prior to transfer of the material to the process chamber.

3. The gas-loading and packaging apparatus of claim 2, wherein the gas supply system is further configured to, in a second transfer mode during which the material is transferred via the second passageway from the loading chamber to the process chamber, increase the pressure level in the process chamber sufficient to prevent the flow of contaminants from the loading chamber into the process chamber.

4. The gas-loading and packaging apparatus of claim 2, further comprising a cryocooler configured to cool one or more of: the loading chamber, the process chamber, and the packaging chamber to a cryogenic temperature of about 93 Kelvin or lower.

5. The gas-loading and packaging apparatus of claim 2, further comprising a cryogenically cooled container placed in the packaging chamber, wherein the cryogenically cooled container maintains its contents at a temperature of about 93 Kelvin or lower.

6. The gas-loading and packaging apparatus of claim 2, further comprising a sealing mechanism for sealing the first passageway after the material is received within a cryogenically cooled container placed in the packaging chamber.

7. The gas-loading and packaging apparatus of claim 6, wherein the sealing mechanism includes a thermal seal and a vapor seal.

8. The gas-loading and packaging apparatus of claim 3 wherein the gas supply system is further configured to, in the second transfer mode, increase the process chamber pressure to at least about 10 Torr above the loading chamber pressure.

9. The gas-loading and packaging apparatus of claim 3 wherein the gas supply system is further configured to, in the second transfer mode, increase the process chamber pressure to the range of about 10 Torr to about 50 Torr above the loading chamber pressure.

10. The gas-loading and packaging apparatus of claim 2, further comprising a first linear transfer apparatus disposed in the loading chamber for transferring the material from the process chamber to outside of the gas-loading and packaging apparatus.

11. The gas-loading and packaging apparatus of claim 1, further comprising a second linear transfer apparatus disposed in the process chamber for transferring the cryogenically cooled container from the process chamber.

12. The gas-loading and packaging apparatus of claim 1, further comprising a process control circuit configured to:
receive mass measurements from the scale in the process chambers obtained while the material is being loaded with hydrogen gas;
calculate a change of mass of the material based on the measurements; and
determine when the material is loaded with a predetermined amount of hydrogen gas based on the change in mass of the material.

13. The gas-loading and packaging apparatus of claim 12, wherein, to determine when the material is loaded with the predetermined amount of hydrogen gas, the process control circuit is further configured to compare the change of mass of the material to a threshold.

14. The gas-loading and packaging apparatus of claim 12, wherein, to determine when the material is loaded with the predetermined amount of hydrogen gas, the process control circuit is further configured to calculate the amount of hydrogen loaded onto the material based on the mass change.

15. The gas-loading and packaging apparatus of claim 1, wherein the second pressure level is sufficiently below the process chamber pressure to prevent the flow of contaminants from the packaging chamber into the process chamber while the material is being transferred into the packaging chamber.

16. The gas-loading and packaging apparatus of claim 15, wherein the second pressure level comprises a pressure level at least 10 Torr below the loading chamber pressure.

17. The gas-loading and packaging apparatus of claim 1, further comprising automated packaging equipment in the packaging chamber for packaging the material within a cryogenically cooled container placed inside the packaging chamber.

18. A gas-loading and packaging apparatus comprising:
a process chamber configured to receive a liquid material to be loaded with hydrogen gas;
a scale positioned inside the process chamber for measuring a mass of the liquid material while the liquid material is loaded with the hydrogen gas;
a packaging chamber connected by a first passageway to the process chamber and configured to receive the liquid material from the process chamber through the first passageway;
a gas supply system including a gas source for supplying hydrogen gas under pressure to the process chamber and the packaging chamber, the gas supply system configured to:
in a loading mode, supply hydrogen gas to the process chamber to increase the process chamber pressure to a first pressure level sufficient to effect the loading of liquid material with hydrogen gas while the liquid material is disposed within the process chamber; and
in a first transfer mode, supply hydrogen gas to the packaging chamber to increase the packaging chamber pressure to a second pressure level lower than the first pressure level to enable transfer of the liquid material from the process chamber to the packaging chamber.

19. The gas-loading and packaging apparatus of claim 18, further comprising:
a loading chamber connected by a second passageway to the process chamber and configured to receive the liquid material prior to it being placed into the process chamber; and
a vacuum pump for evacuating the loading chamber prior to transfer of the liquid material to the process chamber.

20. The gas-loading and packaging apparatus of claim 19, wherein the gas supply system is further configured to, in a second transfer mode during which the liquid material is transferred via the second passageway from the loading chamber to the process chamber, increase the pressure level in the process chamber sufficient to prevent the flow of contaminants from the loading chamber into the process chamber.
